(19) United States
(12) Patent Application Publication
(10) Pub. No.: US 2016/0247189 A1
(43) Pub. Date: Aug. 25, 2016

(54) SYSTEM AND METHOD FOR USE OF DYNAMIC BANNERS FOR PROMOTION OF EVENTS OR INFORMATION

(71) Applicant: SPOTIFY AB, Stockholm (SE)

(72) Inventors: Steve Shirley, New York City, NY (US); Will Meyer, New York City, NY (US); Chris Angove, New York City, NY (US)

(21) Appl. No.: 15/048,646

(22) Filed: Feb. 19, 2016

Related U.S. Application Data
(60) Provisional application No. 62/118,670, filed on Feb. 20, 2015.

(51) Int. Cl. G06Q 30/02

(52) U.S. Cl. CPC G06Q 30/0252; G06Q 30/0277

(57) ABSTRACT

In accordance with an embodiment, described herein are a system and method for use of dynamic banners for the promotion of events or other information. The system allows for scaling in the management of advertising creatives, by enabling advertisements, promotions, or other information to be generated dynamically in realtime, using a template and set of inputs, for example text, image, voice, or click links. An advertisement server receives advertisement requests from a client, and provides a tag for a dynamic banner, which is sent back to the client; so that a dynamic creative service, which receives a tag for use with a particular event, for example a concert, can determine creative assets to be returned to the client, which are then rendered within the dynamic banner in the form of a promotion.

### CLAIM OF PRIORITY

This application claims the benefit of priority to U.S. Provisional Patent Application No. 62/118,670, titled “SYSTEM AND METHOD FOR USE OF DYNAMIC BANNERS FOR PROMOTION OF CONCERTS OR OTHER EVENTS OR INFORMATION”, filed Feb3 20, 2015, which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. Field of Invention

Embodiments of the invention are generally related to the providing of media content, and advertising, and are particularly related to a system and method for use of dynamic banners for the promotion of events or other information.

2. Background

Today's consumers enjoy the ability to access a tremendous amount of media content, such as music and videos, at any location or time of day, using a wide variety of media devices. Media content providers, for example music streaming services such as Spotify, are ideally positioned to promote artist-related merchandise, concerts, and other events or information, generally through the use of advertising creatives. However, this can require thousands of creatives to be manually trafficked and optimized, making creative management a limiting factor, These are some examples of the type of environment in which embodiments of the present invention can be used.

### SUMMARY

In accordance with an embodiment, described herein are a system and method for use of dynamic banners for the promotion of events or other information. The system allows for scaling in the management of advertising creatives, by enabling advertisements, promotions, or other information to be generated dynamically in realtime, using a template and set of inputs, for example text, image, voice, or click links. An advertisement server receives advertisement requests from a client, and provides a tag for a dynamic banner, which is sent back to the client; so that a dynamic creative service, which receives a tag for use with a particular event, for example a concert, can determine creative assets to be returned to the client, which are then rendered within the dynamic banner in the form of a promotion.

### BRIEF DESCRIPTION OF THE FIGURES

FIG. 1 illustrates an example of a system for providing media content, in accordance with an embodiment.

FIG. 2 further illustrates an example of a system for providing media content, in accordance with an embodiment.

FIG. 3 further illustrates an example of a system for providing media content, in accordance with an embodiment.

FIG. 4 illustrates a system for use of dynamic banners for promotion of events or information in accordance with an embodiment.

FIGS. 5A and 5B illustrate an exemplary template for use of dynamic banners, in accordance with an embodiment.

FIG. 6 illustrates several examples of dynamically generated creatives, in accordance with an embodiment.

FIG. 7 is a flowchart that illustrates a process for supporting the use of dynamic banners for promotion of events or information, in accordance with an embodiment.

### DETAILED DESCRIPTION

As described above, media content providers, for example music streaming services such as Spotify, are ideally positioned to promote artist-related merchandise, concerts, and other events or information, generally through the use of advertising creatives. However, this can require thousands of creatives to be manually trafficked and optimized, making creative management a limiting factor.

In accordance with an embodiment, described herein are a system and method for use of dynamic banners for the promotion of events or other information. The system allows for scaling in the management of advertising creatives, by enabling advertisements, promotions, or other information to be generated dynamically in realtime, using a template and set of inputs, for example text, image, voice, or click links. An advertisement server receives advertisement requests from a client, and provides a tag for a dynamic banner, which is sent back to the client; so that a dynamic creative service, which receives a tag for use with a particular event, for example a concert, can determine creative assets to be returned to the client, which are then rendered within the dynamic banner in the form of a promotion.

In accordance with an embodiment, the system comprises a computer including a processor, and a media server executing thereon; an advertisement server, which receives advertisement requests from a client, and provides a tag for a dynamic banner, which is sent back to the client; and a dynamic creative service, which receives a tag for a concert or other event or information, and determines creative assets to be returned to the client, which are then rendered at the dynamic banner in the form of a promotion.

In accordance with an embodiment, the system is provided by a media content provider in association with a streaming music service, and wherein the promotion is for a concert or other artist-related event or information.

In accordance with an embodiment, the dynamic banner is sized to fit into an available advertisement slot at a client application.

The above and additional embodiments are described in further detail below.

### Media Content Environment

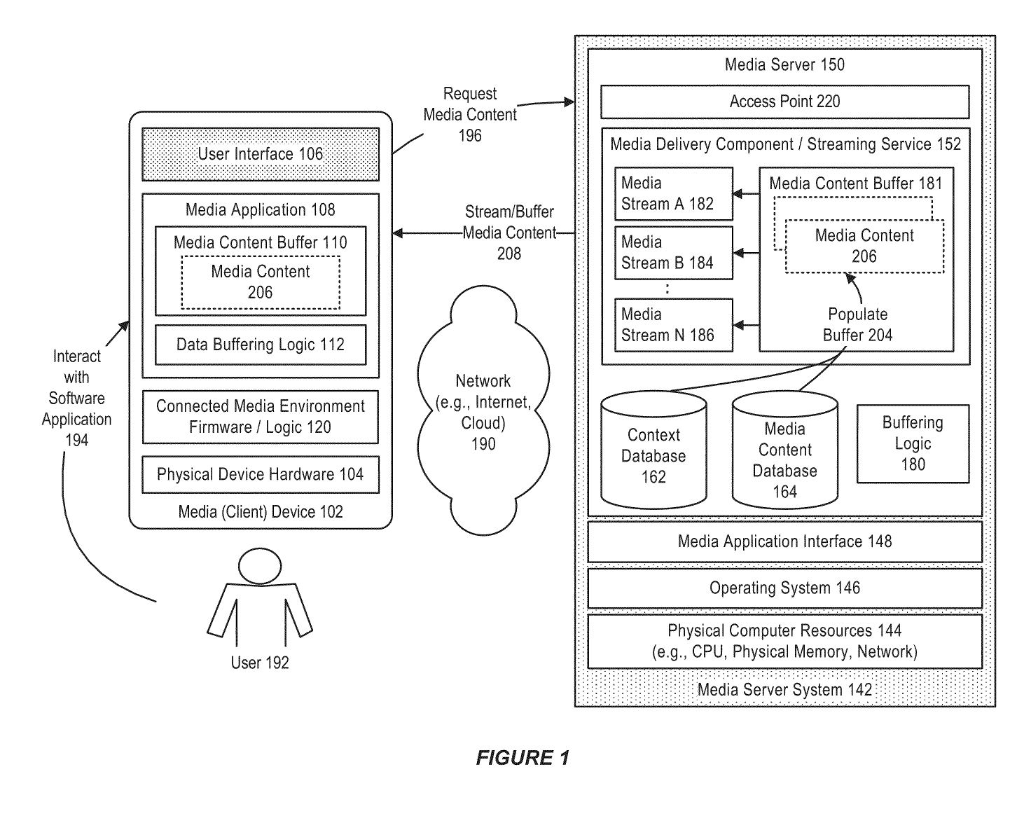

FIG. 1 illustrates an example of a system for providing media content, in accordance with an embodiment.

As illustrated in FIG. 1, in accordance with an embodiment, a media device 102, operating as a client device, can receive and play media content provided by a backend media server system 142 (media server), or by another system or peer device. In accordance with an embodiment, the client device can be, for example, a personal computer system, handheld entertainment device, tablet device, smartphone, television, audio speaker, in-car entertainment system, or other type of electronic or media device that is adapted or able to prepare a media content for presentation, control the presentation of media content, and/or play or otherwise present media content.

In accordance with an embodiment, each of the client device and the media server can include, respectively, one or more physical device or computer hardware resources 104, 144, such as one or more processors (CPU), physical memory, network components, or other types of hardware resources.

Although, for purposes of illustration, a single client device and media server are shown, in accordance with an embodiment a media server can support the simultaneous use of a plurality of client devices. Similarly, in accordance with an embodiment, a client device can access media content provided by a plurality of media servers, or switch between different media streams produced by one or more media servers.

In accordance with an embodiment, the client device can optionally include a user interface 106, which is adapted to display media options, for example as an array of media tiles, thumbnails, or other format, and to determine a user interaction or input. Selecting a particular media option, for example a particular media tile or thumbnail, can be used as a command by a user and/or the client device, to the media server, to download, stream or otherwise access a corresponding particular media content item or stream of media content.

In accordance with an embodiment, the client device can also include a media application 108, together with an in-memory client-side media content buffer 110, and a data buffering logic 112, which can be used to control the playback of media content received from the media server, for playing either at a requesting client device (i.e., controlling device) or at a controlled client device (i.e., controlled device), in the manner of a remote control. A connected media environment firmware or logic 120 enables the device to participate within a connected media environment.

In accordance with an embodiment, the data buffering logic, together with the media content buffer, enables a portion of media content items, or samples thereof, to be pre-buffered at a client device. For example, while media options are being prepared for display on a user interface, e.g., as media tiles or thumbnails, their related media content can be pre-buffered at the same time, and cached by one or more client devices in their media content buffers, for prompt and efficient playback when required.

In accordance with an embodiment, the media server system can include an operating system 146 or other processing environment which supports execution of a media server 150 that can be used, for example, to stream music, video, or other forms of media content to a client device, or to a controlled device.

In accordance with an embodiment, the media server can provide a subscription-based media streaming service, for which a client device or user can have an associated account and credentials, and which enable the user's client device to communicate with and receive content from the media server. A received media-access request from a client device can include information such as, for example, a network address, which identifies a destination client device to which the media server should stream or otherwise provide media content, in response to processing the media-access request.

For example, a user may own several client devices, such as a smartphone and an audio speaker, which can play media content received from a media server. In accordance with an embodiment, identifying information provided with a media-access request can include an identifier, such as an IP address, MAC address, or device name, which identifies that the media-access request is intended for use with a particular destination device. This allows a user, for example, to use their smartphone as a controlling client device, and their audio speaker as a controlled client device to which media content should be sent. The media server can then send the requested media and/or forward the media-access request to the audio speaker, even though the request originated at the user's smartphone.

In accordance with an embodiment, a media application interface 148 can receive requests from client devices, or from other systems, to retrieve media content from the media server. A context database 162 can store data associated with the presentation of media content by a client device, including, for example, a current position within a media stream that is being presented by the client device, or a playlist associated with the media stream, or one or more previously-indicated user playback preferences. The media server can transmit context information associated with a media stream to a client device that is presenting that stream, so that the context information can be used by the client device, and/or displayed to the user. The context database can be used to store a media device's current media state at the media server, and synchronize that state between devices, in a cloud-like manner. Alternatively, media state can be shared in a peer-to-peer manner, wherein each device is aware of its own current media state which is then synchronized with other devices as needed.

For example, in accordance with an embodiment, when the destination client device to which the media content is being streamed changes, from a controlling device to a controlled device, or from a first controlled device to a second controlled device, then the media server can transmit context information associated with an active media content to the newly-appointed destination device, for use by that device in playing the media content.

In accordance with an embodiment, a media content database 164 can include media content, for example music, songs, videos, movies, or other media content, together with metadata describing that media content. The metadata can be used to enable users and client devices to search within repositories of media content, to locate particular media content items.

In accordance with an embodiment, a buffering logic 180 can be used to retrieve or otherwise access media content items, in response to requests from client devices or other systems, and to populate a server-side media content buffer 181, at a media delivery component/streaming service 152, with streams 182, 184, 186 of corresponding media content data, which can then be returned to the requesting device or to a controlled device.

In accordance with an embodiment, a plurality of client devices, media server systems, and/or controlled devices, can communicate with one another using a network, for example the Internet 190, a local area network, peer-to-peer connection, wireless or cellular network, or other form of network. For example, a user 192 can interact 194 with the user interface at a client device, and issue requests to access media content, for example the playing of a selected music or video item at their client device or at a controlled device, or the streaming of a media channel or video stream to their client device or to a controlled device.

In accordance with an embodiment, the user's selection of a particular media option can be communicated 196 to the media server, via the server's media application interface. The media server can populate its media content buffer at the server 204, with corresponding media content, 206 including one or more streams of media content data, and can then communicate 208 the selected media content to the user's client device, or to the controlled device as appropriate, where it can be buffered in a media content buffer for playing at the device.

In accordance with an embodiment, and as further described below, the system can include a server-side media gateway or access point 220, or other process or component, which operates as a load balancer in providing access to one or more servers, for use in processing requests at those servers. The system can enable communication between a client device and a server via an access point at the server, and optionally the use of one or more routers, to allow requests from the client device to be processed either at that server and/or at other servers.

For example, in a Spotify media content environment, most Spotify clients connect to various Spotify back-end processes via a Spotify “accesspoint”, which forwards client requests to other servers, such as sending one or more metadataproxy requests to one of several metadataproxy machines on behalf of the client or end user.

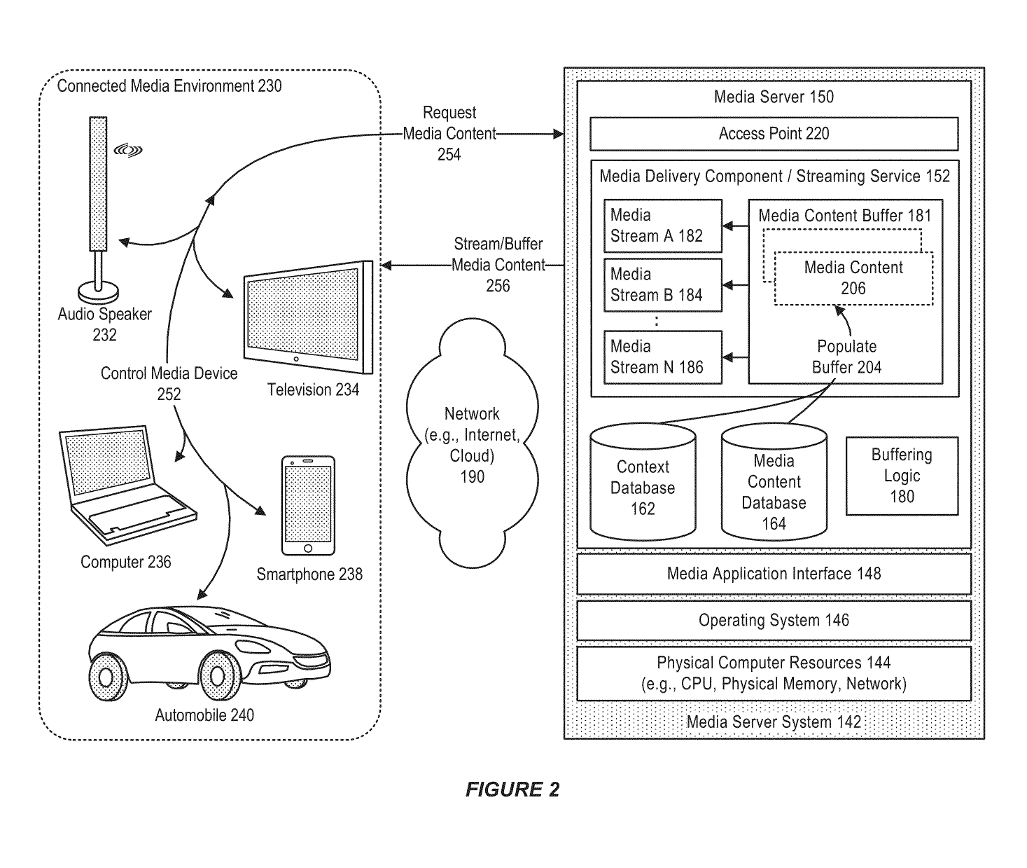

FIG. 2 further illustrates an example of a system for providing media content, in accordance with an embodiment.

As illustrated in FIG. 2, in accordance with an embodiment, a connected media environment 230, for example a Spotify Connect environment, enables communication between a client device and the server-side access point in a connected manner from the perspective of a user. Examples of the types of media device that can be provided within a connected media environment include audio speakers 232, televisions 234, computers 236, smartphones 238, and in-car entertainment systems 240, or other types of media device.

In accordance with an embodiment, a client device having an application user interface can act as a controlling client device, to control 252 the playback of media content at a controlled device. In accordance with an embodiment, a client device can itself act as a media gateway or access point, for use by other devices within the system for providing media content.

In accordance with an embodiment, a controlled device can also include a media application, which in the case of an audio speaker, television or similar device can be included within the device itself as firmware logic, or within, for example, a separate set-top box or similar after-market device.

As described above, in accordance with an embodiment, a user can interact with the user interface at a client device, and issue requests to access media content, for example the playing of a selected music or video item at their client device or at a controlled device, or the streaming of a media channel or video stream to their client device or to a controlled device.

For example, in accordance with an embodiment, a user can request that media content be buffered, streamed or received and played at a controlling client device such as a smartphone, and simultaneously buffered, streamed or received for playing at one or more controlled devices, such as an audio speaker. Similarly, for example, the user can issue a media-change request 254 to change a media channel, in response to which the media server can switch the media channel at the controlled device, and thereafter continue to stream or buffer media content 256 for the switched channel, at the controlled device.

As described above, in some instances, a portion of the media content can be pre-buffered at the controlled device, so that the switching to the channel at the controlled device operates in a seamless manner.

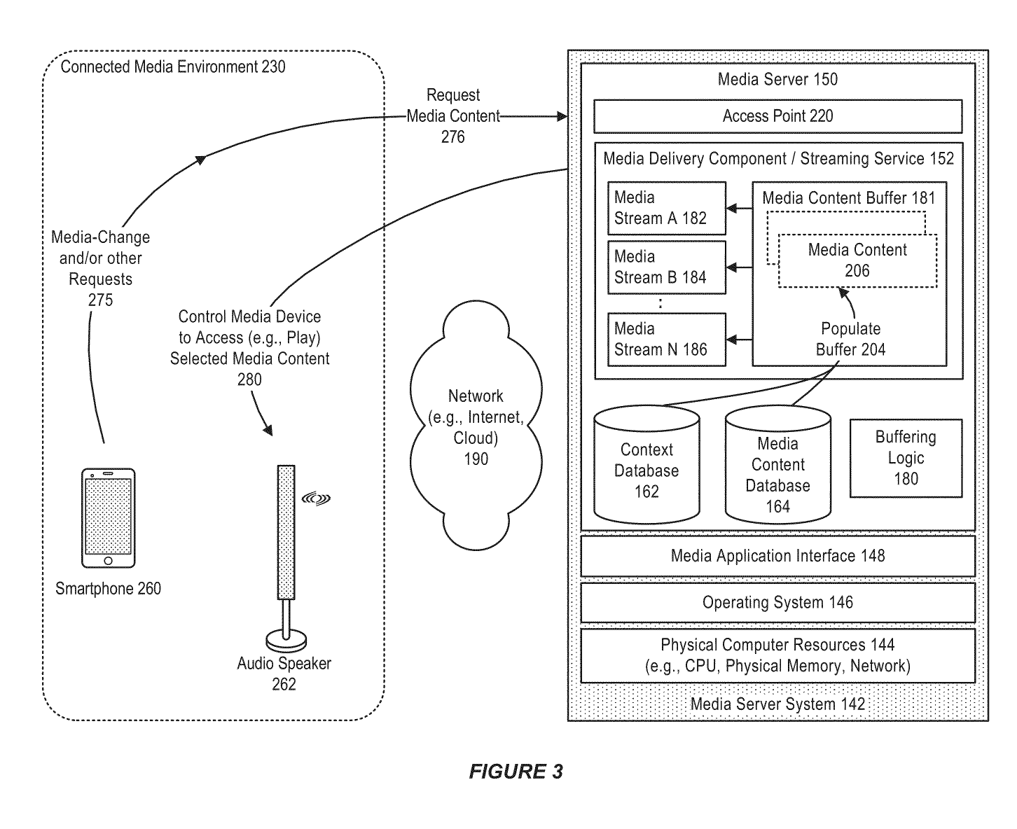

FIG. 3 further illustrates an example of a system for providing media content, in accordance with an embodiment.

As illustrated in FIG. 3, a user can utilize, for example, a smartphone 260 in combination with an audio speaker 262, to issue a media-change request 275 from the smartphone, for example, to change a media channel at the audio speaker. The request can be received by the media gateway or access point, and communicated to the local media server, or to other media servers, as a request for media content 276, which can then respond by controlling the destination device (in this example, the audio speaker) to access (e.g., play) the selected media content 280.

### Dynamic Banners

In accordance with an embodiment, the system supports the use of dynamic banners for the promotion of events or other information, including enabling advertisements, promotions, or other information to be generated dynamically in realtime, using a template and set of inputs, for example text, image, voice, or click links.

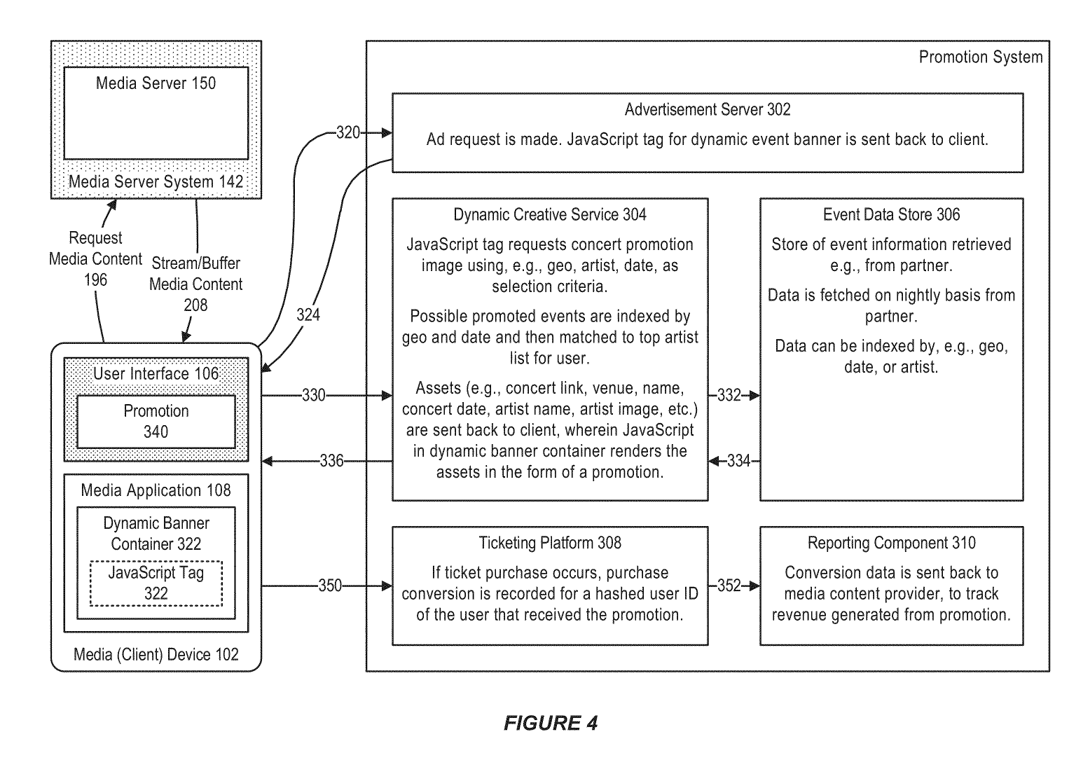

FIG. 4 illustrates a system for use of dynamic banners for promotion of events or information, in accordance with an embodiment.

As illustrated in FIG. 4, in accordance with an embodiment, the system can include, or provide access to, an advertisement server 302, for example a DoubleClick for Publishers (DFP) ad server, a dynamic creative service 304, an event data store 306, a ticketing platform 308, and a reporting component 310, for example a Hadoop environment, each of which are described in further detail below.

In accordance with an embodiment, the advertisement server enables an advertisement request to be made by a client 320, which can be, for example, a media device operating as a client device and including a media application, as described above.

In response to receiving the advertisement request, the advertisement server causes a tag for a dynamic banner 322, which in accordance with an embodiment can be a JavaScript or other type of tag, to be sent 324 to the client, where it can be processed by a dynamic banner container 326 at the client.

In accordance with an embodiment, at the dynamic creative service, the tag can be used to request 330, for example, a promotion for an event or other type of information using, for example, a geo-targeted, artist-related, date-related, or other value as a selection criteria. For example, a plurality of potential promoted concerts can be indexed by geolocation and date, and then matched to atop artist list for a particular user.

In accordance with an embodiment, the event data store includes a store of event-related (e.g., concert-related) data or information, which can be received on a nightly or other periodic basis from a third-party partner, and indexed by geolocation, date, or artist. Upon receiving a request 332 from the dynamic creative service, an appropriate event (e.g., concert) information can be provided 334 to the dynamic creative service.

In accordance with an embodiment, at the dynamic creative service, creative assets for use in promoting the event, for example, one or more of a concert link, venue, concert date, artist name, or artist image, can then be sent back 336 to the client. Once returned to the client, the JavaScript in the dynamic banner container at the client can render the assets in the form of a promotion 340.

In accordance with an embodiment, at the ticketing platform 350, which can be provided by another third-party, if a ticket purchase subsequently occurs as a result of the promotion rendered at the client, that purchase conversion can be recorded, for example as a hashed user ID of the user that originally received the promotion.

In accordance with an embodiment, when the reporting component, which can be provided for example as a Hadoop environment, receives 352 an indication of a ticket purchase associated with a promotion, a conversion data at user and artist level can be provided to the media content provider and/or logged to track revenue generated from the promotions. Such information can be used to attribute ticket sales to a particular promotion, so that the media content provider receives credit for that ticket revenue, while also illustrating to the artist or the ticketing partner that the particular promotion has been successful in driving revenue to those entities.

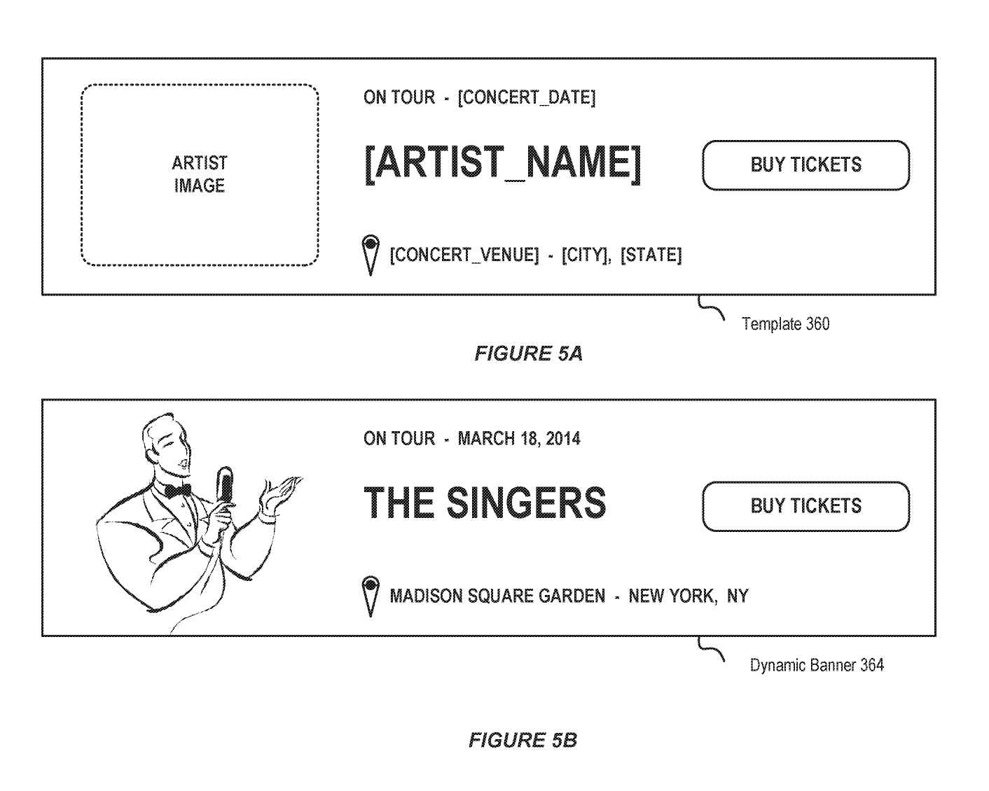

FIGS. 5A and 5B illustrate an exemplary template for use of dynamic banners, in accordance with an embodiment. For example, FIG. 5A illustrates a template 360 that allows data to be fit into a display format appropriate for a variety of different sizes of advertisement slot. A dynamically generated (e.g., 728×90) or dynamic banner 364, which in accordance with an embodiment can fit into available advertisement slots in desktop and web player or other client applications) can resemble that shown in FIG. 5B. The dynamic banner can be modified to fit into another frame/slot size by modifying the JavaScript used to render the assets coming from the dynamic creative service.

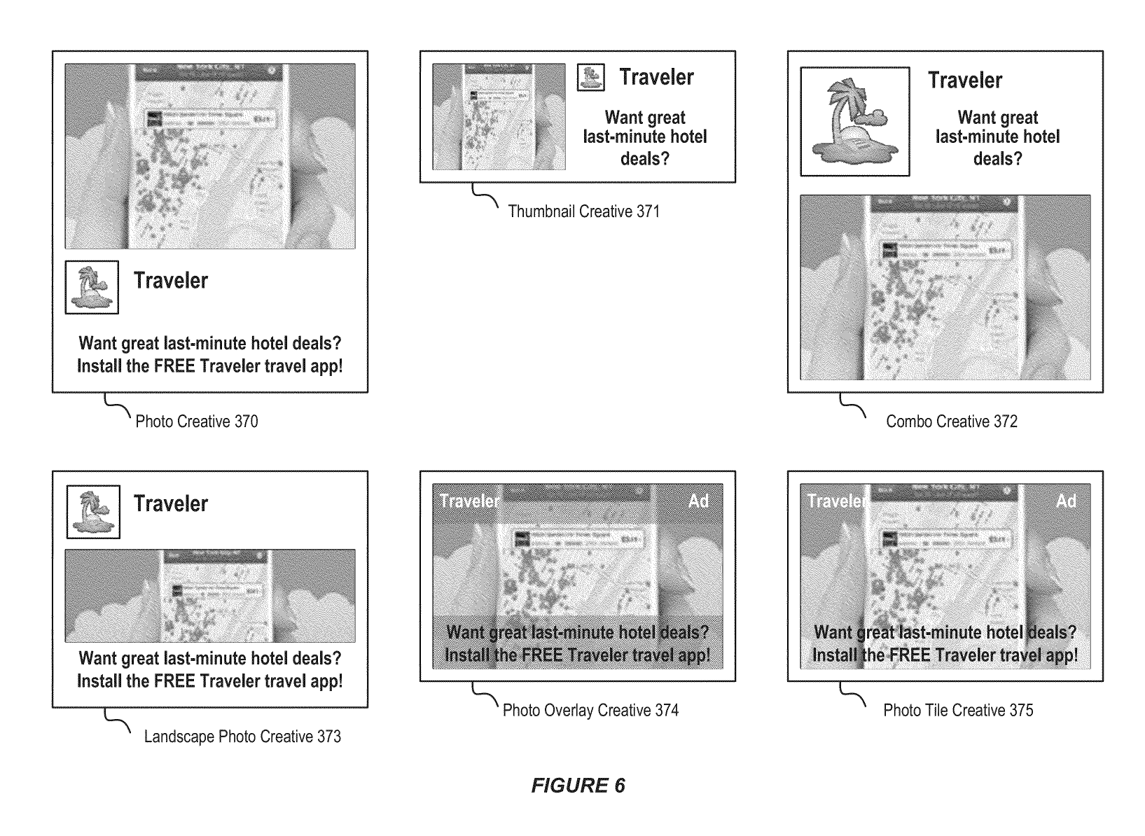

FIG. 6 illustrates several examples of dynamically generated creatives, in accordance with an embodiment.

As illustrated in FIG. 6, dynamically generated creatives can be utilized in native advertising executions, wherein the advertisement content needs to be modified in some way to better fit the look and feel of a particular, e.g., app, website, or platform where the advertisement is being served.

For example, the content format can be generated in a manner specific to a user and the user's context, and in a variety of different sizes/layouts, such as a photo creative 370, thumbnail creative 371, combo creative 372, landscape photo creative 373, photo overlay creative 374, or photo tile creative 375. Examples of the types of input that can be used to generate the creative include the location of the user, a text, an image of a map, or a URL for an offer. The creative can then be sized to fit into different contexts and views.

In accordance with an embodiment, while much of the description herein describes the use of advertisement, and concert or event promotion, the technique can be similarly used to promote sharing of information other than advertising. Dynamically rendered creatives can be placed anywhere within a client environment, and used to promote a variety of different types of information.

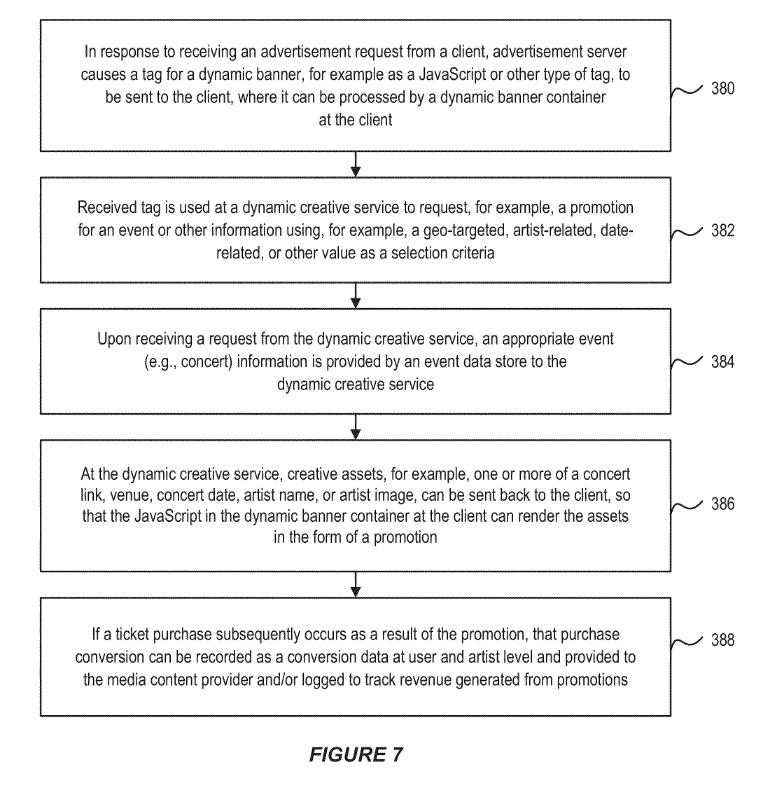

FIG. 7 is a flowchart that illustrates a process for supporting the use of dynamic banners for promotion of events or information, in accordance with an embodiment.

As illustrated in FIG. 7, at step 380, in response to receiving an advertisement request from a client, an advertisement server causes a tag for a dynamic banner, for example as a JavaScript or other type of tag, to be sent to the client, where it can be processed by a dynamic banner container at the client.

At step 382, the received tag is used at a dynamic creative service to request, for example, a promotion for an event or other information using, for example, a geo-targeted, artist-related, date-related, or other value as a selection criteria.

At step 384, upon receiving a request from the dynamic creative service, an appropriate event (e.g., concert) information is provided by an event data store to the dynamic creative service.

At step 386, at the dynamic creative service, creative assets, for example, one or more of a concert link, venue, concert date, artist name, or artist image, can be sent back to the client, so that the JavaScript in the dynamic banner container at the client can render the assets in the form of a promotion.

At step 388, if a ticket purchase subsequently occurs as a result of the promotion, that purchase conversion can be recorded as a conversion data at user and artist level and provided to the media content provider and/or logged to track revenue generated from promotions.

### Exemplary Use Cases

In accordance with an embodiment, exemplary use cases can include an advertisement sales revenue model, in which, e.g., artists, promoters, ticketing platforms, venues can purchase inventory and select a specific list of artist/concerts/venues to promote. Alternatively, an affiliate fees model can allows an affiliate fee to be paid for each ticket by the ticketing platforms for the traffic/sales driven. In accordance with other embodiments, other types of use cases can be supported.

Embodiments of the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated.

What is claimed is:

1. A system for use of dynamic banners for promotion of concerts or other events or information, comprising:
a computer including a processor, and a media server executing thereon;
an advertisement server, which receives advertisement requests from a client, and provides a tag for a dynamic banner, which is sent back to the client; and
a dynamic creative service, which receives a tag for a concert or other event or information, and determines creative assets to be returned to the client, which are then rendered at the dynamic banner in the form of a promotion.

2. The system of claim 1, wherein the system is provided by a media content provider in association with a streaming music service, and wherein the promotion is for a concert or other artist-related event or information.

3. The system of claim 1, wherein the dynamic banner is sized to fit into an available advertisement slot at a client application.

4. A method of using dynamic banners for promotion of concerts or other events or information, comprising:
providing, at a computer including a processor, a media server executing thereon providing an advertisement server, which receives advertisement requests from a client, and provides a tag for a dynamic banner, which is sent back to the client; and
providing a dynamic creative service, which receives a tag for a concert or other event or information, and determines creative assets to be returned to the client, which are then rendered at the dynamic banner in the form of a promotion.

5. The method of claim 4, wherein the method is performed by a media content provider in association with a streaming music service, and wherein the promotion is for a concert or other artist-related event or information.

6. The method of claim 4, wherein the dynamic banner is sized to fit into an available advertisement slot at a client application.

7. A non-transitory computer readable storage medium, including instructions stored thereon which when read and executed by one or more computers cause the one or more computers to perform the steps comprising:
providing an advertisement server, which receives advertisement requests from a client, and provides a tag for a dynamic banner, which is sent back to the client; and
providing a dynamic creative service, which receives a tag for a concert or other event or information, and determines creative assets to be returned to the client, which are then rendered at the dynamic banner in the form of a promotion.

8. The non-transitory computer readable storage medium of claim 7, wherein the steps are performed by a media content provider in association with a streaming music service, and wherein the promotion is for a concert or other artist-related event or information.

9. The non-transitory computer readable storage medium of claim 7, wherein the dynamic banner is sized to fit into an available advertisement slot at a client application.
